(19) United States
(12) Patent Application Publication
(10) Pub. No.: US 2025/0274056 A1
(43) Pub. Date: Aug. 28, 2025

(54) Method of operating an inverter circuit, inverter arrangement and drive unit

(71) Applicant: SEG Automotive Germany GmbH, Stuttgart (DE)

(72) Inventor: Nima SAADAT, Stuttgart (DE)

(21) Appl. No.: 19/049,268

(22) Filed: Feb. 10, 2025

(30) Foreign Application Priority Data
Feb. 23, 2024 (DE) 102024105115.9

(51) Int. Cl. H02M 7/483; H02M 1/088; H02M 1/32

(52) U.S. Cl. CPC H02M 7/483; H02M 1/088; H02M 1/32

(57) ABSTRACT

An inverter circuit has at least one half-bridge having a low side and a high side. The low side has at least one first and at least one second controllable semiconductor switching elements connected in parallel to one another between a first DC voltage terminal and a center terminal of the inverter circuit. The high side has at least one third controllable semiconductor switching element connected between a second DC voltage terminal and the center terminal. A main gate driver circuit and an auxiliary gate driver control the switching elements to operate the inverter circuit in a normal operation mode and a safe state.

### CROSS-REFERENCE TO RELATED APPLICATIONS

This application claims priority to German Patent Application No. 10 2024 105 115.9 filed Feb. 23, 2024 which is hereby incorporated by reference in its entirety.

### TECHNICAL FIELD

The present disclosure relates to a method for operating an inverter circuit, an inverter arrangement and a drive unit.

### BACKGROUND

Inverter circuits, such as rectifiers or power converters, are electrical circuits for converting one type of electrical current into another type of current, i.e. for example from a direct current into an alternating current or vice versa. For this purpose, one or more half-bridges connected in parallel can be used in such inverter circuits, whereby a half-bridge consists of two switching elements connected in series to a voltage source.

Conventionally, three-phase inverter circuits have three half-bridges (one for each phase), each comprising a high-side and a low-side. One or more high-side switches are provided in the high-side and one or more low-side switches in the low-side. The number of switches used is determined by the maximum load current that is to flow through the inverter circuit.

To operate electrical machines, for example in fully electric or hybrid vehicles, voltages of up to 800 V are required in the DC link circuit between the electrical machine and the battery. In inverter circuits that convert the DC voltage of the battery into an AC voltage for the electrical machine and vice versa, controllable semiconductor switching elements such as SiC-MOSFETs (silicon carbide metal-oxide-semiconductor field-effect transistors) are conventionally used as switching elements. SiC MOSFETs are more efficient and have lower switching losses compared to other switching elements such as insulated-gate bipolar transistors (IGBTs), especially in high-voltage applications, due to their lower on-resistance, particularly with partial loads, i.e. when the maximum voltage or current is not required. However, the costs for IGBTs are considerably lower than the costs of (SiC) MOSFETs with similar areas of application, for example with similar maximum load currents.

If a fault occurs in an inverter circuit, the inverter circuit should be transferred to a safe state. For example, the safe state, particularly if a permanent magnet synchronous machine (PMSM) is used as an electrical machine in a vehicle drive, comprises actively short-circuiting the electrical machine by closing all low-side switches or all high-side switches, i.e. switching them to the conductive state, in order to avoid high overvoltages on the DC link and on the switches. Such a safe-state is called active short-circuit, ASC.

Depending on the design of the PMSM and the speed of the electrical machine, this can lead to enormous inrush currents in the closed switching elements. These inrush currents can last for several milliseconds before decaying to the continuous current of steady-state operation. The inrush current can lead to a sharp rise in the junction temperature in the switches, up to temperatures that damage or destroy the switching elements. To protect the inverter circuit, several switches are therefore conventionally connected in parallel on each side of each half-bridge, whereby the total current is distributed over several switches. When using (SiC) MOSFETs, however, this leads to high costs.

WO 2020/179633 A1, U.S. Pat. No. 11,277,125 B2 and CN 117094270 A show inverters in which two switching elements are connected in parallel in the low side and/or high side, whereby one of the switching elements is a SiC MOSFET and the other switching element is a (SiC) bipolar transistor.

### SUMMARY

An inverter circuit, a method for operating an inverter circuit, an inverter arrangement and a drive unit having the features of the independent patent claims are proposed. Advantageous embodiments are the subject-matter of the dependent claims and the following description.

The disclosure is based on an inverter circuit with at least one half-bridge having a low side and a high side. The low side has at least one first controllable semiconductor switching element and at least one second controllable semiconductor switching element, which are connected in parallel to one another between a first DC voltage terminal and a center terminal of the inverter circuit. Each of the first controllable semiconductor switching elements is a metal-oxide-semiconductor field-effect transistor, in particular a SiC MOSFET, and each of the second controllable semiconductor switching elements is a bipolar transistor with an insulated gate electrode (IGBT). The high side has at least one third controllable semiconductor switching element, which is connected between a second DC voltage terminal and the center terminal. The at least one third controllable semiconductor switching element is in particular a metal-oxide-semiconductor field-effect transistor (MOSFET), for example a SiC MOSFET. The inverter circuit is adapted or configured in particular to supply phase windings of an electrical machine with an output current via the center terminals. A number of half bridges of the inverter circuit corresponds appropriately to a number of phase windings of the electrical machine which is to be operated via the inverter circuit.

The gist of the disclosure is that, if a safe state of the inverter circuit is requested and an active short circuit is to be produced in the low side of the inverter circuit, i.e. the semiconductor switching elements between the center terminal and the first DC voltage terminal are switched to a permanently conductive state, not only the first controllable semiconductor switching elements but also the second controllable semiconductor switching elements are switched to the conductive state. The second controllable semiconductor switching elements are permanently switched to the non-conductive state in a normal operation mode.

When a short circuit is created between the phase windings of the electrical machine, high inrush currents can occur that last for a few milliseconds. Due to the active short circuit, the entire power is applied to the semiconductor switching elements of the inverter circuit. If only the first controllable semiconductor switching elements designed as MOSFETs were to conduct, the high inrush currents would cause the temperature in the first controllable semiconductor switching elements to rise sharply, which could damage them. By also switching the second controllable semiconductor switching elements into the conductive state, the current flow is distributed across several switching elements and thus reduced, so that damage to expensive MOSFETs can be prevented.

Furthermore, in contrast to the use of additional parallel-connected MOSFETs, in particular SIC MOSFETs, the use of bipolar transistors as the second controllable semiconductor switching elements can reduce the costs of the inverter circuit.

In addition, the vehicle in which the inverter circuit is installed can be towed without damaging the inverter circuit, as the current induced by the movement of the electrical machine flows through several semiconductor switching elements and the thermal load on the semiconductor switching elements is therefore reduced.

More specifically, the inverter circuit comprises a main gate driver circuit adapted to control each of the at least one first controllable semiconductor switching elements and each of the at least one third controllable semiconductor switching element. The control of these first and third semiconductor switching elements comprises in particular the switching of the semiconductor switching elements between the conductive and the non-conductive state and vice versa, wherein the main gate driver circuit is designed in particular to control the at least one first controllable semiconductor switching element and the at least one third controllable semiconductor switching element individually or independently of one another. For this purpose, the main gate driver circuit can in particular have a gate driver for each semiconductor switching element that is to be controlled by the main gate driver circuit. Furthermore, the inverter circuit has an auxiliary gate driver which is adapted to switch the at least one second controllable semiconductor switching element permanently to a non-conductive state when the inverter circuit is operated in a normal operation mode and to switch it to a conductive state when the inverter circuit is to be transferred to a safe state.

This is a cost-effective way of preventing damage to the first controllable semiconductor switching elements and other elements of the inverter circuit when the inverter circuit is transferred to a safe state.

In one embodiment, one or more, in particular each, of the at least one half-bridge has in each case a plurality of first controllable semiconductor switching elements and/or a plurality of second controllable semiconductor switching elements, which are connected in parallel between the first DC voltage terminal and the center terminal.

In one embodiment, one or more, in particular each, of the at least one half-bridge has in each case a plurality of third controllable semiconductor switching elements, which are connected in parallel between the second DC voltage terminal and the center terminal.

The number of first controllable semiconductor switching elements corresponds in particular to the number of second controllable semiconductor switching elements, and in particular also to the number of third controllable semiconductor switching elements.

In one embodiment, one or more of the half bridges has a plurality of first controllable semiconductor switching elements and exactly one second controllable semiconductor switching element, all of which are connected in parallel between the first DC voltage terminal and the center terminal.

The first controllable semiconductor switching elements and second controllable semiconductor switching elements can be produced together as one component. Furthermore, it is also conceivable that the component also comprises the third controllable semiconductor switching elements. In particular, all semiconductor switching elements for all phases of the electrical machine can also be combined into one component.

By using several first, second and third controllable semiconductor switching elements, a larger current can be conducted through the inverter circuit. Furthermore, by increasing the number of first and second controllable semiconductor switching elements, the high inrush current flowing when the active short circuit is activated can be distributed over several semiconductor switching elements, so that a lower current flows through each of the semiconductor switching elements, thus protecting the semiconductor switching elements even better against damage.

In one embodiment, the inverter circuit also has a capacitor that is connected between the first DC voltage terminal and the second DC voltage terminal. In particular, the capacitor buffers and smoothes the DC voltage.

The disclosure further relates to a method for operating an inverter circuit. The method comprises operating the inverter circuit in a normal operation mode, in which there is no fault in the inverter circuit or the electrical machine, by switching each of the at least one second controllable semiconductor switching element into a non-conductive state and controlling the at least one first controllable semiconductor switching element and the at least one third controllable semiconductor switching element. In this case, the at least one second controllable semiconductor switching element remains permanently in the non-conductive state during normal operation mode and the conversion between DC voltage and AC voltage is performed only by the at least one first controllable semiconductor switching element and the at least one third controllable semiconductor switching element. The method also includes transferring the inverter circuit to an active short circuit if a safe state is to be activated. For this purpose, the at least one first controllable semiconductor switching element and the at least one second controllable semiconductor switching element are switched to a conductive state, essentially simultaneously. In particular, all first and second controllable semiconductor switching elements are switched (essentially) simultaneously to a conductive state. Furthermore, the at least one third controllable semiconductor switching element is switched to a non-conductive state. If several third controllable semiconductor switching elements are installed in the inverter circuit, all third controllable semiconductor switching elements are switched to the non-conductive state. “Essentially simultaneously” means that simultaneous switching is the aim, but a slight time offset cannot always be avoided due to tolerances and usual component differences.

Because the at least one second controllable semiconductor switching element is switched to the conductive state together with the at least one first controllable semiconductor switching element when the inverter circuit is switched to the safe state, the high inrush current that occurs is distributed over several semiconductor switching elements so that the current flowing through each of the semiconductor switching elements is lower. This prevents the semiconductor switching elements from being damaged when the inverter circuit is switched to the safe state.

In normal operation mode, the at least one first controllable semiconductor switching element and the at least one third controllable semiconductor switching element are controlled in particular by a main gate driver circuit. The main gate driver circuit is adapted in particular to be able to control the at least one first controllable semiconductor switching element and the at least one third controllable semiconductor switching element differently, in particular alternately, i.e. one is conductive and the other one is non-conductive. For this purpose, the main gate driver circuit has, in particular, a gate driver for each semiconductor switching element that is to be controlled by the main gate driver circuit. For this purpose, the main gate driver circuit receives a control signal, in particular from an inverter control unit, which is, for example, a pulse width modulation signal and which indicates how the at least one first controllable semiconductor switching element and the at least one third controllable semiconductor switching element are to be controlled.

The disclosure also relates to an inverter arrangement comprising the inverter circuit as described above and an inverter control unit which is adapted, in particular in terms of programming, to carry out all the method steps of a method according to the disclosure.

The disclosure also relates to a drive unit comprising an electrical machine and the inverter arrangement.

Further advantages and embodiments of the disclosure are shown in the description and the accompanying drawing.

The disclosure is illustrated schematically in the drawing by means of embodiment examples and is described below with reference to the drawing.

### BRIEF DESCRIPTION OF THE DRAWINGS

FIG. 1 shows the course over time of a current flowing through an inverter circuit to an electrical machine in normal operation mode and during an active short circuit,

FIG. 2 shows a block diagram of an inverter circuit that is adapted to carry out the method according to the disclosure, in embodiments,

FIG. 3 shows a flow chart of a method according to the disclosure, in embodiments.

### DETAILED DESCRIPTION

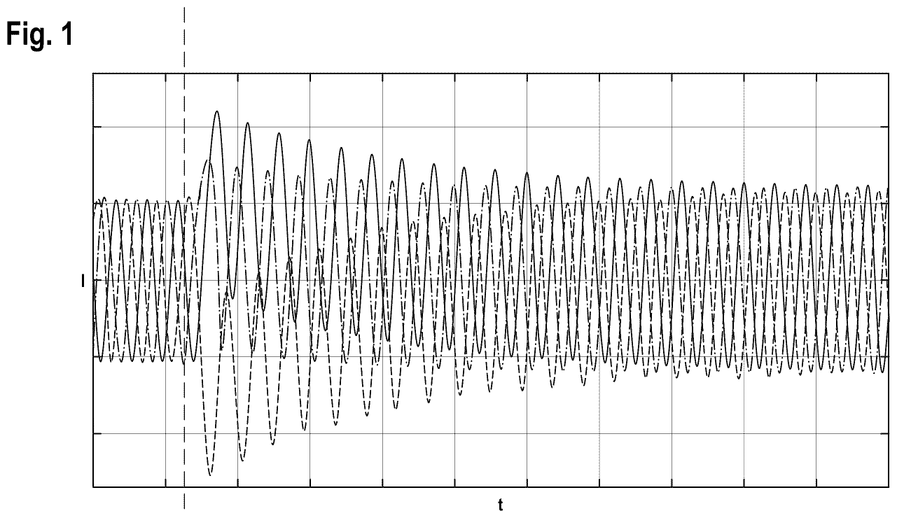

FIG. 1 shows a curve of a current I over time t, the current flowing through an inverter circuit to an electrical machine of an electric drive unit in normal operation mode and then during an active short circuit. The inverter circuit does not have to be an inverter circuit according to the disclosure, but can also be a conventional inverter circuit. The electrical machine here is a three-phase electrical machine and each of the curves (solid line, dashed line, dash-dotted line) shows the current in one of the three phases. The current curve represents the total current for each phase. In the section to the left of the dashed vertical line, the inverter circuit is in normal operation mode, while in the section to the right of the dashed vertical line, the inverter circuit has been switched to the safe state, which is an active short circuit.

In normal operation mode, currents run within the current limits for which the switching elements on the low side and high side are designed. At the time of the dashed vertical line, the safe state is activated in the inverter circuit, for example because a fault has occurred in the electric drive unit. For this purpose, an active short circuit is generated in the high side or the low side, i.e. the switching elements of the corresponding side are switched to a conductive state. Due to inductive effects, in particular the counter-electromotive force (counter-EMF), the current can increase to a multiple of the current flowing from the inverter circuit to the electrical machine during normal operation mode. Semiconductor switching elements, especially MOSFETs, are particularly sensitive to temperature, which means that the temperature in the semiconductor switching elements can rise to such an extent that they are damaged or even destroyed.

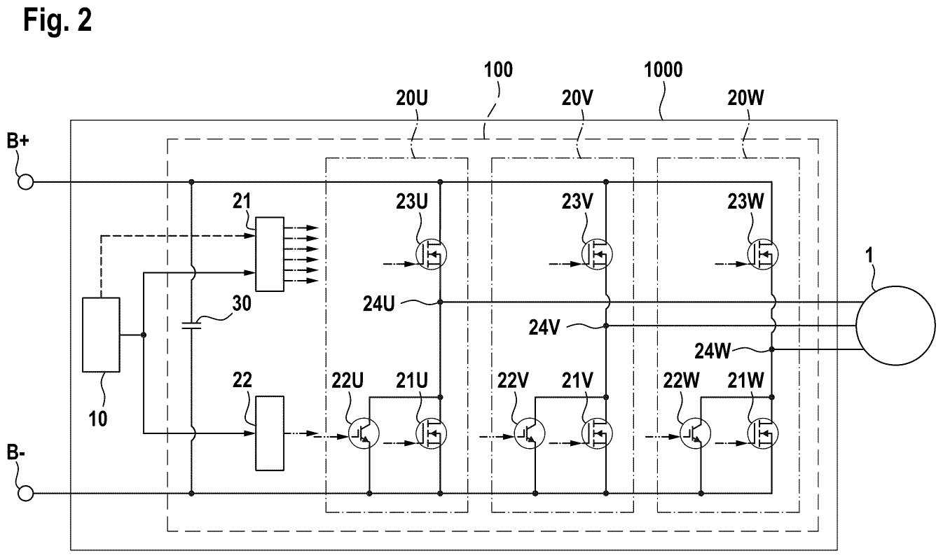

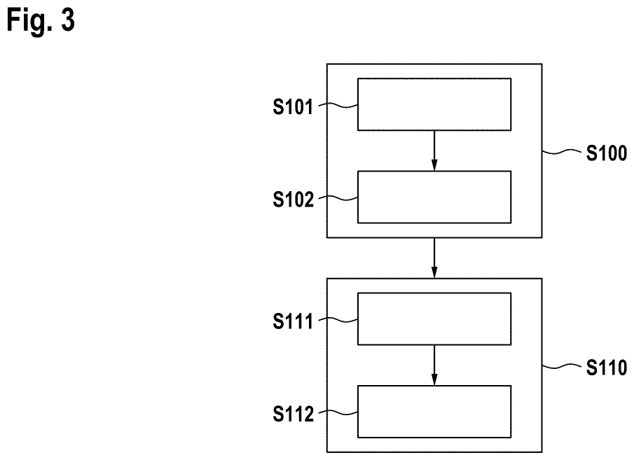

FIG. 2 shows a block diagram of an inverter arrangement 1000, which is adapted to carry out the method according to the disclosure. FIG. 3 shows a flow diagram of an embodiment of the method according to the disclosure. In the following, both figures will be described together.

The inverter arrangement 1000 has an inverter control unit 10 and an inverter circuit 100. The inverter circuit 100 is connected on an input side to a first DC voltage terminal B−, which is in particular an ground terminal, and a second DC voltage terminal B+. On an output side, the inverter circuit 100 is connected to an electrical machine 1. In the embodiment shown, the electrical machine 1 is a three-phase electrical machine with the phases U, V and W. The inverter circuit 100 is adapted to convert the DC voltage applied via the first DC voltage terminal B− and the second DC voltage terminal B+ into a three-phase AC voltage, which is supplied to the electrical machine 1, and vice versa.

For this purpose, the inverter circuit 100 has a half-bridge 20U, 20V, 20W with a low side and a high side for each phase. Each of the low sides has a first controllable semiconductor switching element 21U, 21V, 21W and a second controllable semiconductor switching element 22U, 22V, 22W. The first controllable semiconductor switching element 21U, 21V, 21W and the second controllable semiconductor switching element 22U, 22V, 22W of each low side are connected in parallel between the first DC voltage terminal B− and a center terminal 24U, 24V, 24W of the inverter circuit 100. The inverter circuit 100 is connected to the electrical machine 1 via the center terminals 24U, 24V, 24W. On the high side, a third controllable semiconductor switching element 23U, 23V, 23W is connected between the second DC voltage terminal B+ and the center terminal 24U, 24V, 24W.

The first controllable semiconductor switching elements 21U, 21V, 21W and the third controllable semiconductor switching elements 23U, 23V, 23W are each MOSFETs, in particular SiC MOSFETs, while the second controllable semiconductor switching elements 22U, 22V, 22W are bipolar transistors with an insulated gate electrode (IGBT).

In the embodiment shown, each of the half bridges 20U, 20V, 20W has only one first controllable semiconductor switching element 21U, 21V, 21W, one second controllable semiconductor switching element 22U, 22V, 22W and one third controllable semiconductor switching element 23U, 23V, 23W. However, the disclosure is not limited to such a configuration and each of the half bridges 20U, 20V, 20W may have a plurality of the respective first, second and/or third controllable semiconductor switching elements 21U, 21V, 21W, 22U, 22V, 22W, 23U, 23V, 23W. The number of semiconductor switching elements used depends on the maximum current. If several first, second and third controllable semiconductor switching elements 21U, 21V, 21W, 22U, 22V, 22W, 23U, 23V, 23W are used per half bridge 20U, 20V, 20W, the first and second controllable semiconductor switching elements 21U, 21V, 21W, 22U, 22V, 22W can be connected in pairs in parallel to each other, i.e. a first and a second controllable semiconductor switching element 21U, 21V, 21W, 22U, 22V, 22W are combined in a group and connected in parallel to each other. The various pairs of first and second controllable semiconductor switching elements 21U, 21V, 21W, 22U, 22V, 22W are in turn connected in parallel to one another between the first DC voltage terminal B− and the center terminal 24U, 24V, 24W. For this purpose, the inverter circuit 100 has the same number of first controllable semiconductor switching elements 21U, 21V, 21W and second controllable semiconductor switching elements 22U, 22V, 22W. Alternatively, all first controllable semiconductor switching elements 21U, 21V, 21W can be connected in parallel and all second controllable semiconductor switching elements 22U, 22V, 22W can be connected in parallel. Then, the number of first controllable semiconductor switching elements 21U, 21V, 21W can be selected independently of the number of second controllable semiconductor switching elements 22U, 22V, 22W. The plurality of third controllable semiconductor switching elements 23U, 23V, 23W are connected in parallel to one another in each half-bridge 20U, 20V, 20W between the second DC voltage terminal B+ and the center terminal 24U, 24V, 24W.

The inverter circuit 100 is adapted so that in normal operation mode only the first controllable semiconductor switching elements 21U, 21V, 21W and third controllable semiconductor switching elements 23U, 23V, 23W are switched back and forth between the conductive and non-conductive state, while the second controllable semiconductor switching elements 22U, 22V, 22W remain permanently in a non-conductive state. If the safe state is to be activated in the inverter circuit 100, i.e. the low side of the inverter circuit 100 is to be transferred to an active short circuit, all third controllable semiconductor switching elements 23U, 23V, 23W are switched to a non-conductive state and all first and second controllable semiconductor switching elements 21U, 21V, 21W, 22U, 22V, 22W are switched to a conductive state.

The high inrush current that occurs during the transition to the active state (see FIG. 1) thus flows not only through the first controllable semiconductor switching elements 21U, 21V, 21W, but is divided between the first controllable semiconductor switching elements 21U, 21V, 21W and the second controllable semiconductor switching elements 22U, 22V, 22W, which prevents the first controllable semiconductor switching elements 21U, 21V, 21W from overheating and being damaged.

Furthermore, the inverter circuit 100 has a main gate driver circuit 21, which is adapted for switching the first and third controllable semiconductor switching elements 21U, 21V, 21W, 23U, 23V, 23W, and an auxiliary gate driver 22, which is adapted for switching the second controllable semiconductor switching element 22U, 22V, 22W. The connections of the main gate driver circuit 21 to the first and third controllable semiconductor switching elements 21U, 21V, 21W, 23U, 23V, 23W, are marked with dash-dotted arrows and the connections of the auxiliary gate driver 22 to the second controllable semiconductor switching elements 22U, 22V, 22W are marked with dash-two dotted arrows.

The main gate driver circuit 21 and the auxiliary gate driver 22 are connected to the inverter control unit 10, whereby the main gate driver circuit 21 receives control signals (dashed arrow) from the inverter control unit 10, and the main gate driver circuit 21 and the auxiliary gate driver 22 receive a request signal (solid arrows) from the inverter control unit 10, which indicates that the inverter circuit 100 is to be transferred to the safe state. The inverter control unit 10 can, for example, also be part of a higher-level control unit in which other functions, such as hardware-based or software-based safety monitoring of the inverter arrangement 1000 and/or the electrical machine 1 or the electrical drive, are also implemented.

The main gate driver circuit 21 is adapted in particular to be able to control and switch the first controllable semiconductor switching elements 21U, 21V, 21W and the third controllable semiconductor switching elements 23U, 23V, 23W individually. For this purpose, the main gate driver circuit 21 has, in particular, a gate driver for each semiconductor switching element that is to be controlled by the main gate driver circuit 21. Each of the gate drivers controls one of the first and third controllable semiconductor switching elements 21U, 21V, 21W, 23U, 23V, 23W.

The auxiliary gate driver 22 is adapted in particular to be able to control and switch the second controllable semiconductor switching elements 22U, 22V, 22W. All second controllable semiconductor switching elements 22U, 22V, 22W can be controlled with the same line or the same signal, since they do not have to be switched independently of one another, but are all switched to the non-conductive state (normal operation mode) or to the conductive state (active short circuit, safe state) at (essentially) the same time.

The inverter circuit 100 is controlled by the inverter control unit 10.

First, the inverter circuit 100 is operated in normal operation mode in step S100. For this purpose, the second controllable semiconductor switching elements 22U, 22V, 22W are switched to the non-conductive state in step S101. In step S102, the first controllable semiconductor switching elements 21U, 21V, 21W and the third controllable semiconductor switching elements 23U, 23V, 23W are controlled by the main gate driver circuit 21. During normal operation mode, the second controllable semiconductor switching elements 22U, 22V, 22W remain permanently in a non-conductive state. To control the first controllable semiconductor switching elements 21U, 21V, 21W and the third controllable semiconductor switching elements 23U, 23V, 23W, the inverter control unit 10 sends control signals (dashed arrows) to the main gate driver circuit 21. The control signals are, for example, pulse width modulation signals, depending on which the main gate driver circuit 21 controls the first controllable semiconductor switching elements 21U, 21V, 21W and the third controllable semiconductor switching elements 23U, 23V, 23W.

If there is a fault in the electrical machine 1 or the inverter circuit 100, the safe state should be activated. For this purpose, the inverter circuit 100 is transferred to the active short circuit in step S110. For this purpose, the inverter control unit 10 sends a request signal (solid arrows) to request the safe state to the main gate driver circuit 21 and the auxiliary gate driver 22. When the main gate driver circuit 21 receives the request signal, the main gate driver circuit 21 ignores all control signals (dashed arrow) already received and received in the future, e.g. until the main gate driver circuit 21 receives an enable signal from the inverter control unit 10.

In step S111, the third controllable semiconductor switching elements 23U, 23V, 23W are permanently switched to the non-conductive state by the main gate driver circuit 21. In step S112, the first controllable semiconductor switching elements 21U, 21V, 21W are switched to the conductive state by the main gate driver circuit 21 and the second controllable semiconductor switching elements 22U, 22V, 22W are switched to the conductive state by the auxiliary gate driver 22. This should take place simultaneously as far as possible.

In addition, the drive unit can optionally be restarted. After the current has fallen below a threshold value, the inverter control unit 10 can check all start conditions and determine whether a fault or error is still present. If it is determined that the fault or error is no longer present, the inverter control unit 10 first sends a signal to the auxiliary gate driver 22, which then transfers the second controllable semiconductor switching elements 22U, 22V, 22W to the non-conductive state. The inverter control unit 10 then sends an enable signal to the main gate driver circuit 21. The main gate driver circuit 21 is enabled by the enable signal and can control the first and third controllable semiconductor switching elements 21U, 21V, 21W, 23U, 23V, 23W again depending on the control signal received from the inverter control unit 10.

1. An inverter circuit (100) having at least one half-bridge (20U, 20V, 20W), each of said at least one half-bridge (20U, 20V, 20W) comprising:
a low side comprising at least one first controllable semiconductor switching element (21U, 21V, 21W) and at least one second controllable semiconductor switching element (22U, 22V, 22W) connected in parallel between a first DC voltage terminal (B−) and a center terminal (24U, 24V, 24W) of the inverter circuit (100), wherein each of the at least one first controllable semiconductor switching element (21U, 21V, 21W) is a metal-oxide-semiconductor field-effect transistor and each of the at least one second controllable semiconductor switching element (22U, 22V, 22W) is an insulated gate bipolar transistor,
a high side comprising at least one third controllable semiconductor switching element (23U, 23V, 23W) connected between a second DC voltage terminal (B+) and the center terminal (24U, 24V, 24W), wherein each of said at least one third controllable semiconductor switching element (21U, 21V, 21W) is a metal-oxide-semiconductor field-effect transistor,
wherein said inverter circuit (100) further comprises:
a main gate driver circuit (21) which is adapted to control each of said at least one first controllable semiconductor switching element (21U, 21V, 21W) and each of said at least one third controllable semiconductor switching element (23U, 23V, 23W), and
an auxiliary gate driver (22) which is adapted to switch the at least one second controllable semiconductor switching element (22U, 22V, 22W) permanently to a non-conductive state when the inverter circuit (100) is operated in a normal operation mode, and to switch it to a conductive state when the inverter circuit (100) is to be transferred to a safe state.

2. The inverter circuit (100) according to claim 1, wherein one or more of the at least one half-bridge (20U, 20V, 20W) has in each case:
a plurality of first controllable semiconductor switching elements (21U, 21V, 21W) and/or a plurality of second controllable semiconductor switching elements (22U, 22V, 22W), which are connected in parallel between the first DC voltage terminal (B−) and the center terminal (24U, 24V, 24W), and/or
a plurality of third controllable semiconductor switching elements (23U, 23V, 23W), which are connected in parallel between the second DC voltage terminal (B+) and the center terminal (24U, 24V, 24W).

3. The inverter circuit (100) according to claim 2, which has in one or more of the at least one half-bridge (20U, 20V, 20W) the same number of first controllable semiconductor switching elements (21U, 21V, 21W) and second controllable semiconductor switching elements (22U, 22V, 22W).

4. The inverter circuit (100) according to claim 2, which has in one or more of the at least one half-bridge (20U, 20V, 20W) a plurality of first controllable semiconductor switching elements (21U, 21V, 21W) and exactly one second controllable semiconductor switching element (22U, 22V, 22W).

5. The inverter circuit (100) according to claim 1, further comprising a capacitor (30) connected between the first DC voltage terminal (B−) and the second DC voltage terminal (B+).

6. A method of operating the inverter circuit (100) according to claim 1, the method comprising:
operating (S100) the inverter circuit (100) in a normal operation mode, comprising:
switching (S101) each of the at least one second controllable semiconductor switching element (22U, 22V, 22W) to a non-conductive state, and
controlling (S102) the at least one first controllable semiconductor switching element (21U, 21V, 21W) and the at least one third controllable semiconductor switching element (23U, 23V, 23W) on the basis of a control signal,
transferring (S110), if a safe state is to be activated, the inverter circuit (100) to an active short circuit, comprising
switching (S111) the at least one first controllable semiconductor switching element (21U, 21V, 21W) and the at least one second controllable semiconductor switching element (22U, 22V, 22W) to a conductive state, and
switching (S112) of the at least one third controllable semiconductor switching element (23U, 23V, 23W) to a non-conductive state.

7. An inverter arrangement (1000) comprising an inverter control unit (10) adapted to perform all method steps of the method according to claim 6, and an inverter circuit (100) having at least one half-bridge (20U, 20V, 20W), each of said at least one half-bridge (20U, 20V, 20W) comprising:
a low side comprising at least one first controllable semiconductor switching element (21U, 21V, 21W) and at least one second controllable semiconductor switching element (22U, 22V, 22W) connected in parallel between a first DC voltage terminal (B−) and a center terminal (24U, 24V, 24W) of the inverter circuit (100), wherein each of the at least one first controllable semiconductor switching element (21U, 21V, 21W) is a metal-oxide-semiconductor field-effect transistor and each of the at least one second controllable semiconductor switching element (22U, 22V, 22W) is an insulated gate bipolar transistor,
a high side comprising at least one third controllable semiconductor switching element (23U, 23V, 23W) connected between a second DC voltage terminal (B+) and the center terminal (24U, 24V, 24W), wherein each of said at least one third controllable semiconductor switching element (21U, 21V, 21W) is a metal-oxide-semiconductor field-effect transistor,
wherein said inverter circuit (100) further comprises:
a main gate driver circuit (21) which is adapted to control each of said at least one first controllable semiconductor switching element (21U, 21V, 21W) and each of said at least one third controllable semiconductor switching element (23U, 23V, 23W), and
an auxiliary gate driver (22) which is adapted to switch the at least one second controllable semiconductor switching element (22U, 22V, 22W) permanently to a non-conductive state when the inverter circuit (100) is operated in a normal operation mode, and to switch it to a conductive state when the inverter circuit (100) is to be transferred to a safe state.

8. Drive unit comprising an electrical machine (1) and the inverter arrangement (1000) according to claim 7.

9. The inverter circuit (100) according to claim 3, which has in each of the at least one half-bridge (20U, 20V, 20W) the same number of first controllable semiconductor switching elements (21U, 21V, 21W) and second controllable semiconductor switching elements (22U, 22V, 22W).

10. The inverter circuit (100) according to claim 4, which has in each of the at least one half-bridge (20U, 20V, 20W) a plurality of first controllable semiconductor switching elements (21U, 21V, 21W) and exactly one second controllable semiconductor switching element (22U, 22V, 22W).

11. The method of claim 6, further comprising
switching (S111) the at least one first controllable semiconductor switching element (21U, 21V, 21W) and the at least one second controllable semiconductor switching element (22U, 22V, 22W) to a conductive state substantially simultaneously.
